(19) United States
(12) Patent Application Publication
(10) Pub. No.: US 2014/0293622 A1
(43) Pub. Date: Oct. 2, 2014

(54) LAMP, IN PARTICULAR AN OPERATION LAMP

(71) Applicant: Trilux Medical GmbH & Co. KG, Amsberg (DE)

(72) Inventor: Hermann Hauschulte, Arnsberg (DE)

(21) Appl. No.: 14/355,878

(22) PCT Filed: Oct. 30, 2012
(86) PCT No.: PCT/EP2012/071466

§ 371 Date: May 2, 2014

(30) Foreign Application Priority Data
Nov. 3, 2011 (DE) 10 2011 085 728.1

(51) Int. Cl. F21V 15/01

(52) U.S. Cl. CPC F21V 15/01
USPC 362/364

(57) ABSTRACT

The invention relates to a lamp, in particular an operation lamp for use in rooms having ceilings having low-turbulence displacement flow (TAV ceilings), having a lamp housing and a primary emission direction of light generated by the lamp. In order to reduce a volume of a negative pressure zone of the displacement flow in the flow direction behind the lamp housing, according to the invention the lamp housing has a plurality of trough-like recesses on the outside.

### CROSS-REFERENCE TO RELATED APPLICATIONS

This application is a Section 371 of International Application No. PCT/EP2012/071466, filed Oct. 30, 2012, which was published in the German language on May 10, 2013, under International Publication No. WO 2013/064490 A1 and the disclosure of which is incorporated herein by reference.

### BACKGROUND OF THE INVENTION

The invention relates to a lamp, in particular an operation lamp for use in rooms having ceilings having low-turbulence displacement flow (TAV ceilings), having a lamp housing and a primary emission direction of light generated by the lamp.

Such lamps are known. In up-to-date operating rooms, to produce a preferably clean atmosphere, preferably germ and dust-free air and, for avoiding turbulences, ceiling-side laminar air is supplied to the respective operating room in the direction of flow from the ceiling towards the floor. Operating lamps, installed in the air space between the TAV ceiling and the operating table, produce a flow resistance with a rear lee side in the flow direction on which turbulences of the air circulating around the lamp occur. As a result of these turbulences, which severely disturb the necessary clean environment of the operating table, particles, germs and the like may be dispersed from the floor and/or form the surroundings of the operating table.

### BRIEF SUMMARY OF THE INVENTION

It is an object of the invention to provide a generic lamp, in particular an operation lamp, the lamp causing a turbulence that is at least reduced.

The object of the invention is already achieved by the lamp housing having a plurality of trough-like recesses on the outside, for reducing a volume of a negative pressure zone of the displacement flow in the flow direction behind the lamp housing.

As a result of the flow passing over said trough-like recesses, a boundary layer around the lamp housing which is intrinsically laminar if the incident air flow is substantially laminar, is transformed into a turbulent boundary layer. This can be attributed among others to a negative pressure generation inside the recesses when air flows past. As a result, the air flow is guided more tightly to the lamp housing. Further, the volume of the negative pressure zone of the displacement flow of the turbulent boundary layer in the flow direction behind the lamp housing is reduced. Thus the turbulence of the air approaching the lamp, i.e. of the displacement air if the lamp is used as an operation lamp, can be clearly reduced. The negative pressure zone of the displacement flow in the flow direction behind the lamp housing can also be described as a lee zone. Usually and especially in their configuration as ball scraper-shaped recesses, such recesses are also referred to as dimples. Those dimples or recesses are arranged adjacent each other for instance in golf balls, the surface in this case being referred to as “dimpled surface”.

As a result of these recesses or dimples, the wind pressure or dynamic pressure on the lamp housing can be reduced. This reduction can amount to 50%. Thus the laminar flow in the region of the lamp housing or in the flow direction behind the housing can be decelerated to a lesser degree and can thus serve as a displacement flow over a greater distance downstream of the lamp housing. Due to the reduced flow resistance, the flow rate of the displacement flow required for displacing the circulating air in the operating area can be reduced, which is perceived as very comfortable by surgeons working in the operating area. Additionally, by the reduction of the flow rate of the displacement air it is possible to minimize the risk of the surgeons catching a cold while working in the operating area. It is possible to put limits to the utilization of these effects by the obligation to comply with a prescribed minimum inflow air rate of the displacement air in order to guarantee sufficient displacement of the ambient air in the operating area. To achieve a preferably undisturbed progress of the air flow, the recess can have a smooth inner surface free of edges. Otherwise, undesired turbulence may be easily produced which may additionally swirl the inflowing air. From the aspect of fluidics, it is favorable for the recesses being dimples that a free of additional inner surface textures. Preferably, the dimples have a smooth inner surface. Advantageously, the recesses being dimples are empty, i.e. free of devices arranged in the interior thereof. Preferably, the rim of the opening which is formed by the recess together with the outside of the housing is rounded.

The recesses can be distributed over the entire outer face of the lamp housing. Preferably, said recesses are provided on the outer face regions of the lamp housing which point in the opposite direction of the primary emission direction, at least with one direction component. Preferably, those areas of the outer face of the lamp housing which are arranged in the negative pressure zone during use, are dimpled, i.e. fully covered by the recesses or dimples. The recesses can also be arranged perpendicularly to the primary emission direction in said outer face areas.

Preferably, the recesses are at least almost regularly or equally distributed on the lamp housing. The recesses can be arranged equally spaced or adjacent to each other. To obtain a preferably symmetrical reduction of the volume of the negative pressure zone of the displacement flow, it is proposed that the recesses be arranged in a spherical geometry that is adapted to the lamp housing. To this end, for example the number of the dimples arranged on circumferential ring-like regions of the same axial extension of the housing can be respectively equal.

For optimizing this effect, the recesses can be arranged in accordance with the principle of maximum distribution density on the outer face of the lamp housing. Thus it is possible to provide for a comprehensive arrangement of the recesses on the outer face of the lamp housing. Thus a surface occupation, i.e. the part of the surface of the recesses in relation to the overall outer surface of the outer face of the lamp housing provided for the recesses, can be more than 50%, preferably more than 60%, more than 70% or more than 85%.

In this context, reference is made to known distributions of recesses or dimples in golf balls, in which a plurality of recesses can be arranged in different patterns. In this case, up to 500 dimples can be arranged in a golf ball in a pattern of 60 spherical triangles and three different dimple sizes, shapes and distributions. Considering that the lamp of the invention may present a larger outer face for the said recesses than said golf ball, even more recesses can be provided, for example 1000 and more. The density of recesses provided on the lamp of the invention can be the same or even higher than in golf balls. But is also possible to provide a lower density of recesses, in which case the recesses may have correspondingly larger opening profiles compared to those in a golf ball. The lamp housing in a semispherical shape can be provided with up to 250 recesses on the outer face thereof. Preferably however, a lamp has a considerably smaller number of recesses, in particular less than 50, advantageously less than 30 or 20 recesses on the outer face of the lamp housing. Therefore, a plurality of recesses can also mean less than 20 recesses. Preferably, at least five recesses are provided. The possible optimum number depends on the flow conditions, geometric conditions and on ratios like surface occupation, opening rim profile, distribution and diameter of the recesses.

Preferably, the recesses are arranged symmetrically with a center axis of the lamp housing, in particular symmetrically with the primary emission direction. Preferably, at least the lamp housing of the lamp is constructed axially symmetrically with the center axis. Preferably, the primary emission direction is parallel to the center axis. The recesses can also be arranged asymmetrically with respect to the center axis of the lamp housing, in particular in a subarea or in several subareas of the lamp housing outer surface that is provided for the recesses. Thus it is possible for example to set a particular negative pressure zone that is asymmetrical with respect to the center axis.

The recesses can each have an opening having a round, particularly circular or oval or polygonal opening rim. Particularly, the recesses can each present a ball scraper-like interior. Preferably, the opening rim can be constructed in an asymmetrical manner with respect to the center axis, in due consideration of the spherical distortion as a consequence of the curvature of space of the lamp housing.

In a lamp which has a favorable shape from the aspect of fluidics, the lamp housing can be ball scraper-like up to semispherical or spherical segment-like, at least in the regions of its outer face which are provided for the recesses. Here, the lamp housing can have a section plane that is provided as a light exit face.

In a simplified structure, the lamp can be configured in a mono-reflex manner.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

One embodiment of the invention will now be described in more detail with reference to the attached drawing. In the drawing it is shown by:

FIG. 1 a lateral view of a prior art lamp;

FIG. 2 a lateral view of an inventive lamp;

FIGS. 3a, 3b an enlarged clipping from an outer face of a lamp in a different embodiment, respectively;

FIG. 4 a lateral view of an operation area including the lamp of FIG. 2.

### DETAILED DESCRIPTION OF THE INVENTION

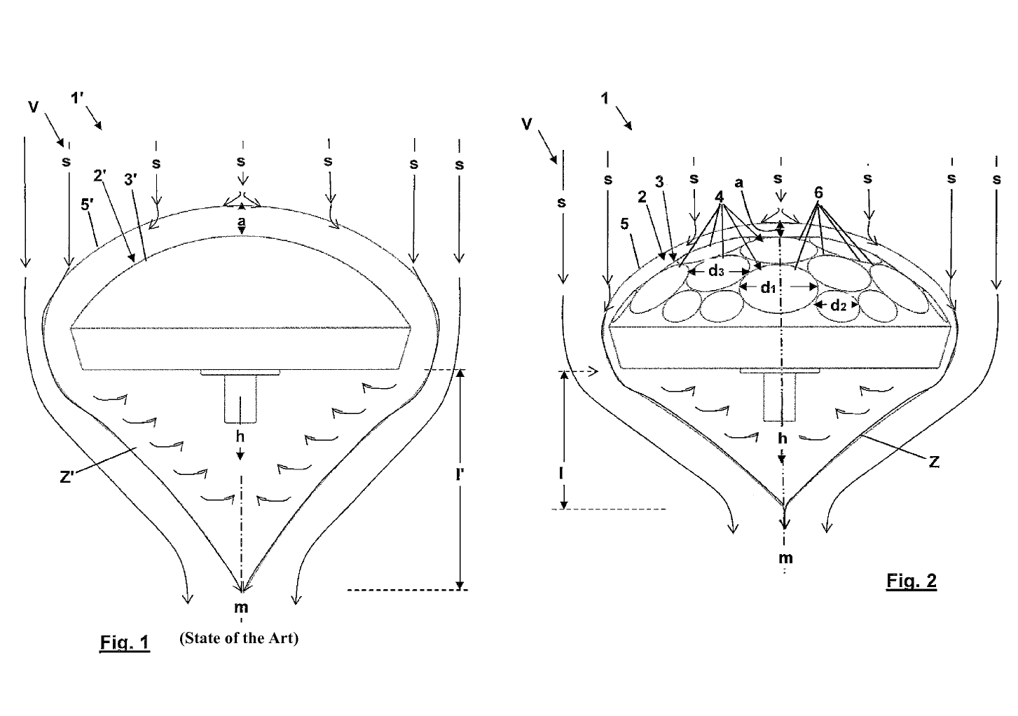

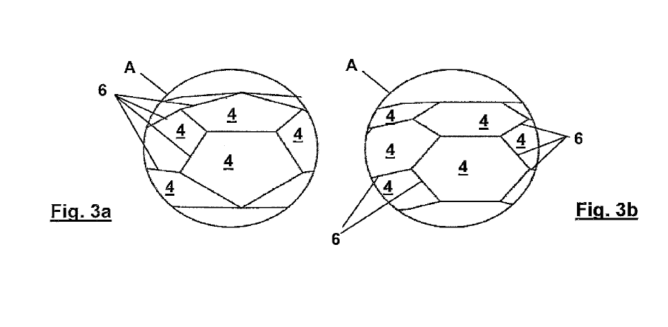

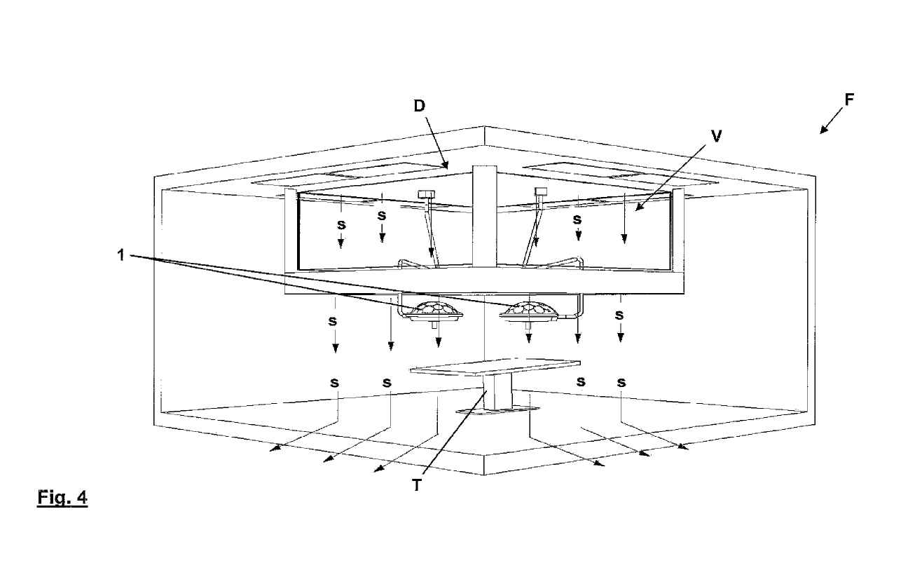

FIG. 1 shows in a lateral view a lamp 1′ according to prior art, the FIGS. 2a, 3 and 3b each show an embodiment of a lamp 1 according to the invention or a clipping A from the same. Illustrated in FIG. 4 is an operating area F, in the present case provided with two of the inventive lamps 1 according to FIG. 2. (To differentiate between the invention and prior art, the reference numbers identifying components of the prior art lamp 1′ are each apostrophized.) In the illustrated examples, the lamp 1, 1′ is constructed as an operation lamp for use in rooms having ceilings having low-turbulence flow, i.e. a substantially laminar displacement flow V (TAV ceilings), as shown for example in FIG. 4. The lamp 1, 1′ has a lamp housing 2, 2′ and emits generated light in a primary emission direction h. In the FIGS. 1 and 2, the direction of flow s of the displacement flow V is parallel to the main direction of flow h.

To reduce the volume of a negative pressure zone Z of the displacement flow V in the flow direction s behind the lamp housing 2, the lamp housing 2 of the lamp 1 according to the invention includes in the embodiments according to the FIGS. 2, 3 and 4 on the outer face 3 thereof a plurality of so-called dimples, trough-like recesses 4, each having a smooth inner surface free of edges, whereas the housing 2′ of lamp 1′ according to prior art shown in FIG. 1 is provided with a smooth outer face 3′.

As soon as the laminar displacement flow V hits the housing 2, 2′, a boundary layer 5, 5′ having a laminar or at least low-turbulence flow is created. If the laminar displacement flow hits the outer face 3 of the lamp 1 that is provided with recesses, a boundary layer 5, in which turbulences (not illustrated) do not occur, is formed due to these recesses 4 which is thinner compared to the boundary layer 5′ in a lamp 1′ without recesses. This situation is schematically shown in FIG. 1 and FIG. 2, wherein the boundary layer 5′ in a known lamp 1′ according to FIG. 1 has a thickness a′ greater than the thickness a of the boundary layer 5 of the inventive lamp 1 according to FIG. 2. Due to the recesses 4, the boundary layer 5 in the lamp 1 of the invention snuggles more tightly against the outer face 3 of the lamp 1.

Downstream of the lamp 1, 1′ in the flow direction s, the negative pressure zone Z, Z′ with turbulences is created, which is surrounded by a laminar displacement flow. This is purely schematically illustrated in the FIGS. 1 and 2 by way of bent short arrows, wherein for reasons of convenience the transitions from the negative pressure zone Z, Z′ to the surroundings are not illustrated. A comparison of both FIGS. 1 and 2 shows that the negative pressure zone Z′ in the known lamp 1′ has a greater length l′ than the length l of the negative pressure zone Z in the lamp 1 of the invention. Accordingly, if the lamp 1 of the invention is approached by the displacement flow V, a corresponding volume of the negative pressure zone Z is reduced compared to the volume of the negative pressure zone Z′ in a case where the known lamp 1 is approached by this displacement flow V.

Due to the turbulences in the negative pressure zone Z, Z′ there is a risk that at the use in an operating area F particulate material, germs or the like are dispersed or aspirated and reach the operating area F or the operating table T. FIG. 4 shows purely schematically and exemplarily the operating area F including the operating table T with a TAV ceiling D for discharging said clean displacement flow V installed above the operating table T. Between the operating table T and the TAV ceiling D, two inventive lamps 1 according to FIG. 2 are installed for illuminating the operating table T, wherein the displacement flow, which is not shown in the drawing, circulates around said two lamps 1. As a result of their negative pressure zone Z, which is small compared to prior art, the risk of particulate material, germs or the like being dispersed and aspirated is clearly reduced.

The surface distribution of the recesses 4 on the outer faces 3 has a direct effect on the thickness a of the boundary layer 5 and the length l of the negative pressure zone Z, i.e. the higher the surface occupation the smaller are the thickness a of the boundary layer 5 and the length l of the negative pressure zone Z. For this reason, a particularly high surface distribution is provided here. In the lamp 1 according to FIG. 2, this is obtained by the recesses 4 being directly adjacent to neighboring recesses 4 while forming crotches, and by the recesses 4 having three different diameters d1, d2, and d3. Further, the recesses 4 here present a ball scraper-like shape having a circular opening rim 6 so that the effect caused by the recesses 4 occurs independently of the direction in which the displacement flow V passes over the recesses 4.

Deviating from this, the recesses 4 in the embodiments of the lamp 1 according to the enlarged clippings A from the outer face 3 in the FIGS. 3a and 3b present a polygonal opening rim 6, wherein the opening rim 6 of the lamp 1 according to FIG. 3a has a pentagonal shape and the opening rim 6 of the lamp 1 according to FIG. 3b has a hexagonal shape, each forming a honeycombed structure without crotches.

In all embodiments of the lamp 1 according to the invention, the recesses 4 are arranged in a uniformly distributed manner. They are only provided on those parts of the outer face 3 of the lamp housing 2 which in relation to the primary emission direction h, point in the opposite direction of the primary emission direction h with one direction component, wherein the lamp housing 2 in these parts presents a ball scraper-like shape having a center axis m parallel to the primary emission direction h. Further, the recesses are arranged in spherical symmetry, i.e. axis-symmetrically with the primary emission direction h.

1.-10. (canceled)

11. A lamp for use in rooms having ceilings (D) having low-turbulence displacement flow (V), comprising a lamp housing (2, 2′) and a primary emission direction (h) of light generated by the lamp (1), wherein in order to reduce a volume of a negative pressure zone (Z) of the displacement flow (V) in the flow direction (s) behind the lamp housing (2), said lamp housing (2) has a plurality of trough-like recesses (4) on the outside.

12. The lamp according to claim 11, wherein the recesses (4) are disposed on areas (3) of the outer face of the lamp housing so as to point in the opposite direction of the primary emission direction (h) with at least one direction component, or perpendicularly to the primary emission direction.

13. The lamp according to claim 11, wherein the recesses (4) are arranged in spherical symmetry with each other.

14. The lamp according to claim 11, wherein the recesses (4) are arranged symmetrically with the primary emission direction (h).

15. The lamp according to claim 11, wherein the recesses (4) are arranged equally spaced or adjacent to each other.

16. The lamp according to claim 11, wherein the recesses (4) are arranged on an outer face (3) of the lamp housing (2) according to the principle of a maximum distribution density.

17. The lamp according to claim 11, wherein the recesses (4) each present an opening having a round, circular or polygonal opening rim (6).

18. The lamp according to claim 11, wherein the recesses each present a ball scraper-like interior.

19. The lamp according to claim 11, wherein the lamp housing (2) presents a ball scraper-like up to a semi-spherical outer face (3) or a spherical segment-like outer face (3).

20. The lamp according to claim 11, wherein it is configured in a mono-reflex manner.
